(19) United States
(12) Patent Application Publication
(10) Pub. No.: US 2017/0322891 A1
(43) Pub. Date: Nov. 9, 2017

(54) DEVICE AND METHOD FOR SECURE DATA STORAGE

(71) Applicant: FREESCALE SEMICONDUCTOR, INC., Austin, TX (US)

(72) Inventors: Bin Feng, Tianjin (CN); Shuwei Wu, Tianjin (CN); Shixiong Lu, Tianjin (CN)

(21) Appl. No.: 15/298,086

(22) Filed: Oct. 19, 2016

(30) Foreign Application Priority Data
May 9, 2016 (CN) 201610301169.X

(51) Int. Cl. G06F 12/14; G06F 21/62

(52) U.S. Cl. CPC G06F 12/1491; G06F 21/62; G06F 2212/1052

(57) ABSTRACT

A device for secure data storage has a host unit that obtains data stored on an external device at an external storage address; a user signal generator that generates a user defined security signal based on the external storage address of the data that indicates a security level of the data; a storage address determining unit that determines an internal storage address for the data based on the security level of the data; and a storage unit that stores the data at the internal storage address corresponding to the security level.

### BACKGROUND

The present invention is directed to a device and method for data storage and, more particularly, to a device and method for secure data storage based on a data security level.

Nowadays more and more applications have various data security requirements, and different security levels may be defined for various data depending on the application. Current data storage solutions do not distinguish differences among data security levels when storing the data, that is, data with different security levels are stored in the same way with the same security protection levels.

It would be desirable to store data with different security levels in device locations with corresponding levels of secure protection.

### SUMMARY

The present invention provides a device and method for secure data storage.

The device for secure data storage comprises a host unit configured to obtain data stored on an external device at an external storage address; a user signal generator configured to generate a user defined security signal based on said external storage address of said data that indicates a security level of said data; a storage address determining unit configured to determine an internal storage address for said data based on said security level of said data; and a storage unit configured to store said data at said internal storage address corresponding to said security level.

The method for secure data storage comprises obtaining data stored on an external device at an external storage address; generating a user defined security signal based on said external storage address of said data that indicates a security level of said data; determining an internal storage address for said data based on said security level of said data; and storing said data at said internal storage address corresponding to said security level.

The above features, and other features and advantages are readily apparent from the following detailed descriptions thereof when taken in connection with the accompanying drawings.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of a device for secure data storage in accordance with an exemplary embodiment;

FIG. 2 is a schematic block diagram of a device for secure data storage in accordance with another exemplary embodiment;

FIG. 3 is a schematic block diagram of an ARM-based system for secure data storage in accordance with an exemplary embodiment;

FIG. 4 is a flow chart of a method for secure data storage in accordance with an exemplary embodiment;

FIG. 5 is a schematic diagram of a FIS (Frame Information Structure);

FIG. 6 is a schematic diagram illustrating processes among a host unit, a user signal generator and a AMBA bridge in accordance with an exemplary embodiment;

FIG. 7 is a schematic diagram of an example of a storage address determining unit; and

FIG. 8 is a schematic diagram of an example of a secure processing unit.

### DETAILED DESCRIPTION

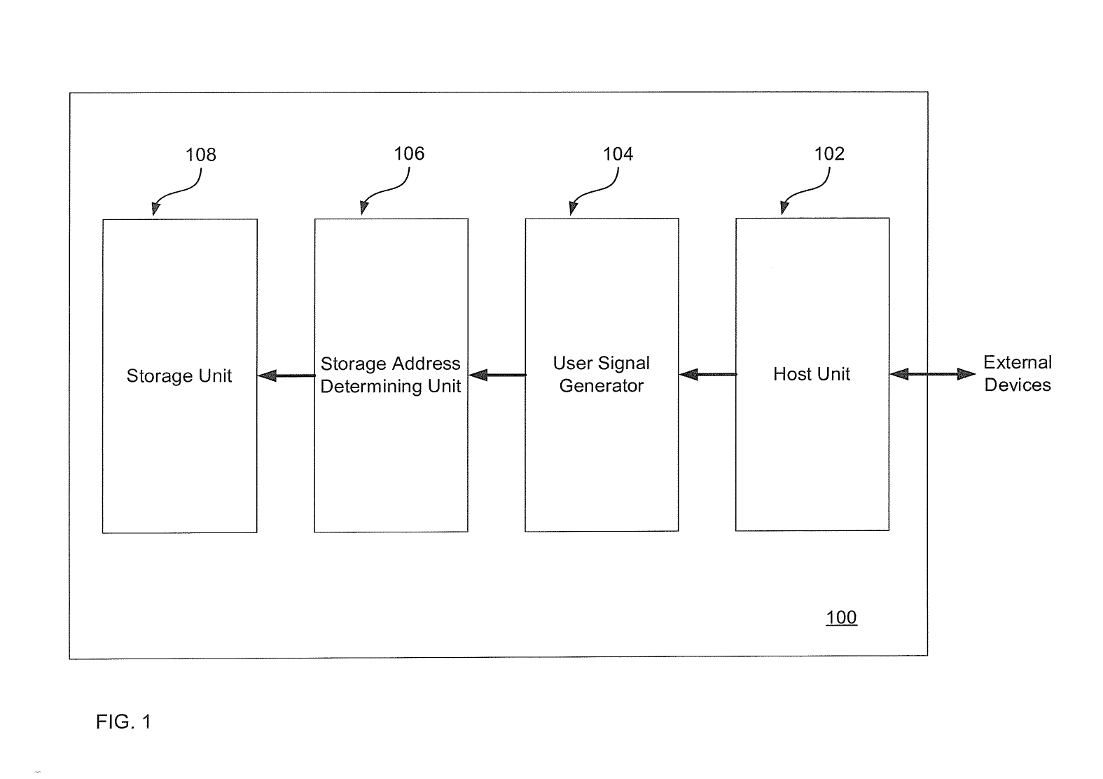

FIG. 1 is a schematic block diagram of a device 100 for secure data storage in accordance with an exemplary embodiment. As shown in FIG. 1, the device 100 includes a host unit 102 configured to receive data stored on an external device at an external storage address. In one example, the external device is connected to the host unit 102 through a port multiplier. The data is transmitted from the external device to the host unit 102 via the port multiplier.

The device 100 also includes a user signal generator 104 in communication with the host unit 102 that generates a user defined security signal based on the external storage address of the data. The user defined security signal indicates a security level of the data.

A storage address determining unit 106 is in communication with the user signal generator 104 and is configured to determine an internal storage address for the data based on the security level of the data. A storage unit 108 is communicatively coupled to the storage address determining unit 106 and is configured to store the data at the internal storage address determined by the storage address determining unit 106.

The user signal generator 104 determines the security level of the data using a security level mapping rule between security levels and external storage addresses of data stored on external devices, where the security levels of data stored at external storage addresses on external devices are known information. Using this known information, the security level mapping rule is preconfigured in the device 100 and can be modified/reconfigured as desired. The security level mapping rule includes corresponding relationships between security levels of the data and the external storage addresses of the data. Thus, according to the security level mapping rule, the user signal generator 104 can determine the security level of the data from the external storage address of the data.

The storage address determining unit 106 determines the internal storage address for the data using an internal storage address mapping rule between security levels and internal storage addresses in the storage unit 108.

The storage unit 108 may comprise various on chip memories and off chip memories as well as their controllers, such as OCRAM (on chip ram), SDRAM, DDR SDRAM, NAND Flash, NOR Flash etc. In a presently preferred embodiment, the storage unit 108 is divided into different regions, and each region can only be read by applications with a security level equal to or higher than a specific security level associated with that region. The internal storage address mapping rule includes corresponding relationships between the security levels and the internal storage addresses in the storage unit 108. In this exemplary embodiment, the storage address determining unit 106 determines an appropriate storage address in the storage unit 108 for the data corresponding to the security level of the data based on the internal storage address mapping rule, so as to provide appropriate storage security protection for data with different security levels. Alternatively, different internal storage address mapping rules may be used by the storage address determining unit 106 to determine the internal storage address for data with different security levels.

In one embodiment, the device 100 pre-assigns an initial internal storage address for the data upon receipt of the data from an external device. Further, in this embodiment, the storage address determining unit 106 comprises a memory management unit (MMU). If the security level of the data is equal to or higher than a predetermined security level, the MMU maps the pre-assigned initial internal storage address for the data to a final internal storage address using the internal storage address mapping rule. The data then is stored at the final internal storage address, which corresponds to the security level in the storage unit 108. The predetermined security level may be a minimum security level, in which case the storage address determining unit 106 may perform the above address mapping process for all data.

In another embodiment, the MMU may include a TLB (Translation Look-aside Buffer). If the security level of the data is equal to or higher than a predetermined security level, the storage address determining unit 106 may use the TLB to perform an address mapping process from the initial internal storage address pre-assigned by the device 100 for the data into a final internal storage address. A TLB is a high speed cache memory that stores recent address mapping results for fast retrieval. When performing an address mapping process, the TLB is checked first to see if a corresponding address mapping result is stored therein. The speed of address mapping process is enhanced using the TLB. The predetermined security level may be the minimum security level, in which case the storage address determining unit 106 may use the TLB to perform the above address mapping process for all data.

If the security level of the data is lower than a predetermined security level, the storage address determining unit 106 uses the initial internal storage address pre-assigned by the device 100 for the data as the final internal storage address of the data according to the internal storage address mapping rule. The data stored at the initial internal storage may be accessible by any user or applications.

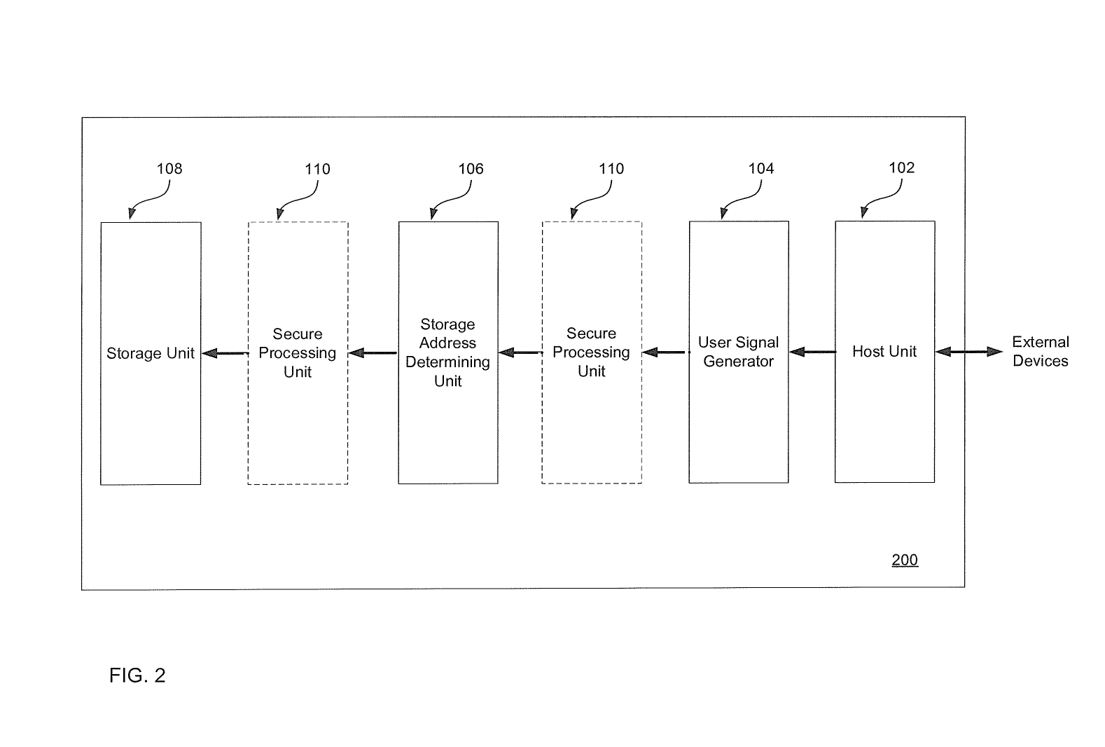

FIG. 2 is a schematic block diagram of a device 200 for secure data storage in accordance with another exemplary embodiment of the present invention. Like the device 100 shown in FIG. 1, the device 200 includes the host unit 102, user signal generator 104, storage address determining unit 106, and storage unit 108. The device 200 further comprises a secure processing unit 110. In FIG. 2, two secure processing units 110 shown using dotted lines indicate that the secure processing unit 110 may be arranged on either the left or right side of the storage address determining unit 106. The secure processing unit 110 determines if secure processing is required to be performed on data being transferred from an external device to the storage unit 108, based on a secure processing requirement of the data, before the data is stored in the storage unit 108. The secure processing unit 110 performs corresponding secure processing on the data if the secure processing unit 110 determines secure processing is required to be performed on the data. If the secure processing unit 110 determines secure processing of the data is not required, then the data is forwarded directly to the next unit (either the storage address determining unit 106 or the storage unit 108) by the secure processing unit 110 without performing any secure processing on the data.

The secure processing requirement is indicated by the user defined security signal of the data. In one example, the user defined security signal includes information that indicates the secure processing requirement of the data. For example, the contents of such information may be “Encryption”, “Decryption” or “No Security Process”. “Encryption” means the data is to be encrypted before it is stored in the storage unit 108. “Decryption” means the data is to be decrypted before it is stored in the storage unit 108. “No Security Process” means no security process is to be performed on the data before it is stored in the storage unit 108. The secure processing unit 110 executes a corresponding process on the data based on the contents of the above information before the data is stored in the storage unit 108.

In another example, the secure processing requirement of the data may be determined based on the security level of the data. For example, if the security level of the data is equal to or higher than a certain security level, the secure processing unit 110 determines that the data must be encrypted before it is stored in the storage unit 108; and if the security level of the data is lower than a certain security level, the secure processing unit 110 determines that the encrypted data must be decrypted or no security process is required to be performed on the unencrypted data before the data is stored in the storage unit 108.

The secure processing performed by the secure processing unit 110 may include encryption or decryption process implemented using various cipher algorithms. For example, if the security level of an encrypted data to be stored in the storage unit 108 is very low, it is not necessary to store it in an encrypted format in the storage unit 108, so the secure processing requirement of the data may indicate to the secure processing unit 110 to decrypt the data before storing it. If the security level of an unencrypted data to be stored in the storage unit 108 is very high, then it is necessary to store it in an encrypted format in the storage unit 108, so the secure processing requirement of the data may indicate to the secure processing unit 110 to encrypt the data before storing it. In this way, the data is stored in the storage unit 108 with appropriate security protection.

All the above components 102-110 are implemented by hardware which can be configured by software or processor.

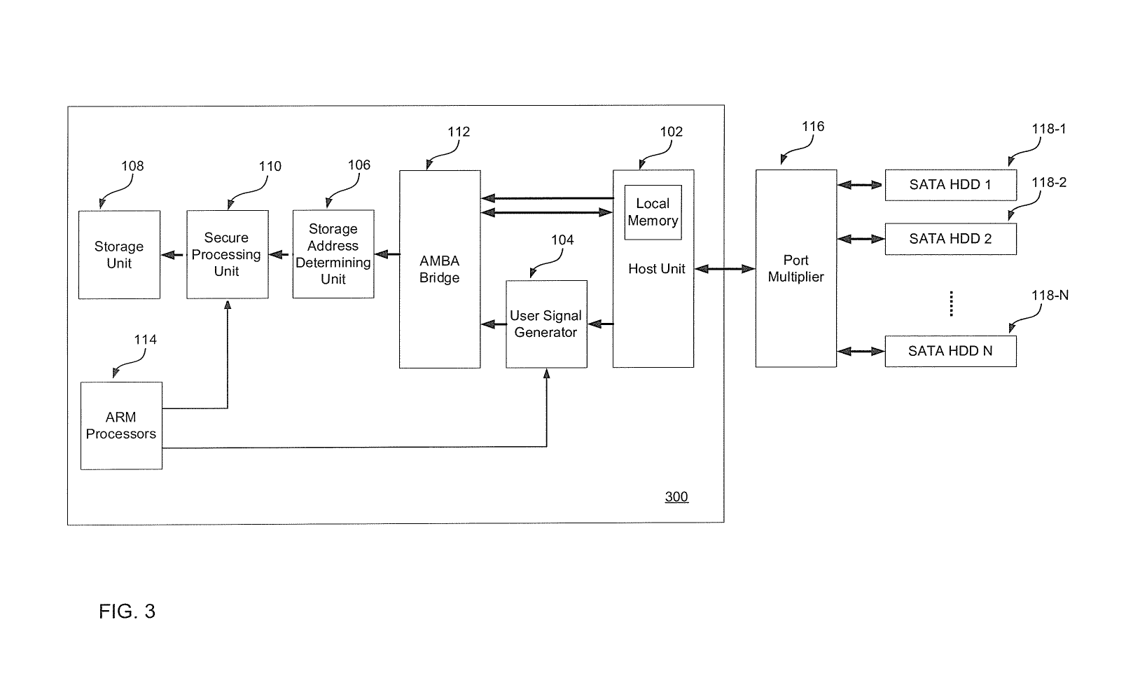

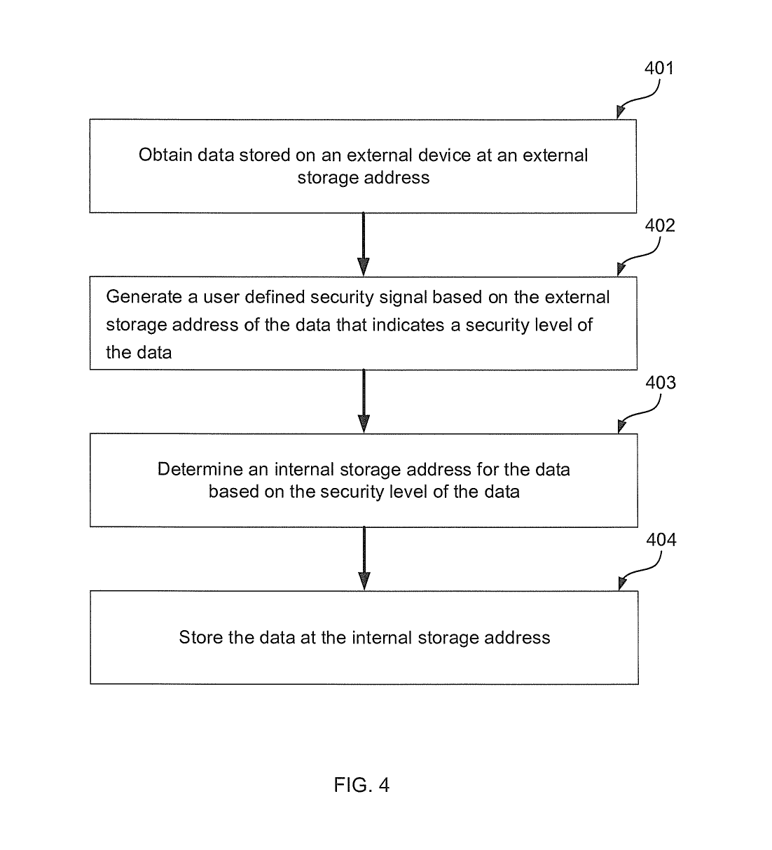

Hereafter, a method for secure data storage will be described through a specific example shown in FIGS. 3 and 4, where FIG. 3 is a schematic block diagram of an ARM-based system for secure data storage and FIG. 4 is a flow chart of a method for secure data storage. In this example, the device 300 is an ARM (Advanced RISC machine) based System on Chip (SoC), the host unit 102 may be a SATA/SAS host unit, and the external devices may be SATA/SAS mass storage devices, such as SATA HDD (Hard Disk Drive) and SSD (Solid-State Drive). The SATA/SAS mass storage devices can be connected to the SATA/SAS host unit 102 in the SOC 300 through a port multiplier 116. In FIG. 3, the external devices are shown as a plurality of SATA HDDs 118-1, 118-2, . . . 118-N. The data is transmitted from the SATA HDDs 118-1, 118-2, . . . 118-N via the port multiplier 116 and stored in the storage unit 108 of the device 300.

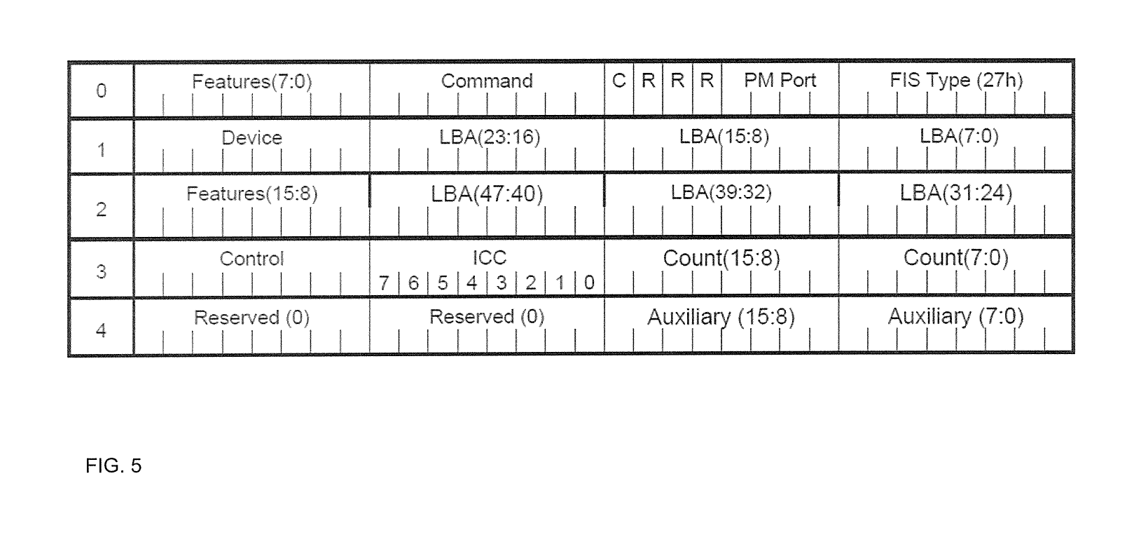

At 401, the host unit 102 obtains data from an external device using an external storage address. When a new access between the SATA host and its endpoint device (for example a SATA HDD) occurs, a FIS (Frame Information Structure) is used at the host side. FIG. 5 is a schematic diagram of a FIS. According to the SATA specification and as shown in FIG. 5, the FIS is used for indicating the feature and destination of specific access between the SATA host and an endpoint device. In FIG. 5, PM Port is used for indicating which endpoint device (for example SATA HDD) attached via the port multiplier 116 will be accessed by the SATA host, and LBA is used for indicating the storage address on the endpoint device. In some cases, a specific storage space or a specific endpoint device is taken as a security space or a security endpoint device. It is desired that data from such specific security space or security endpoint device will be stored in a specific region of the SATA host side (i.e., in the SoC 300) with a corresponding security protection level.

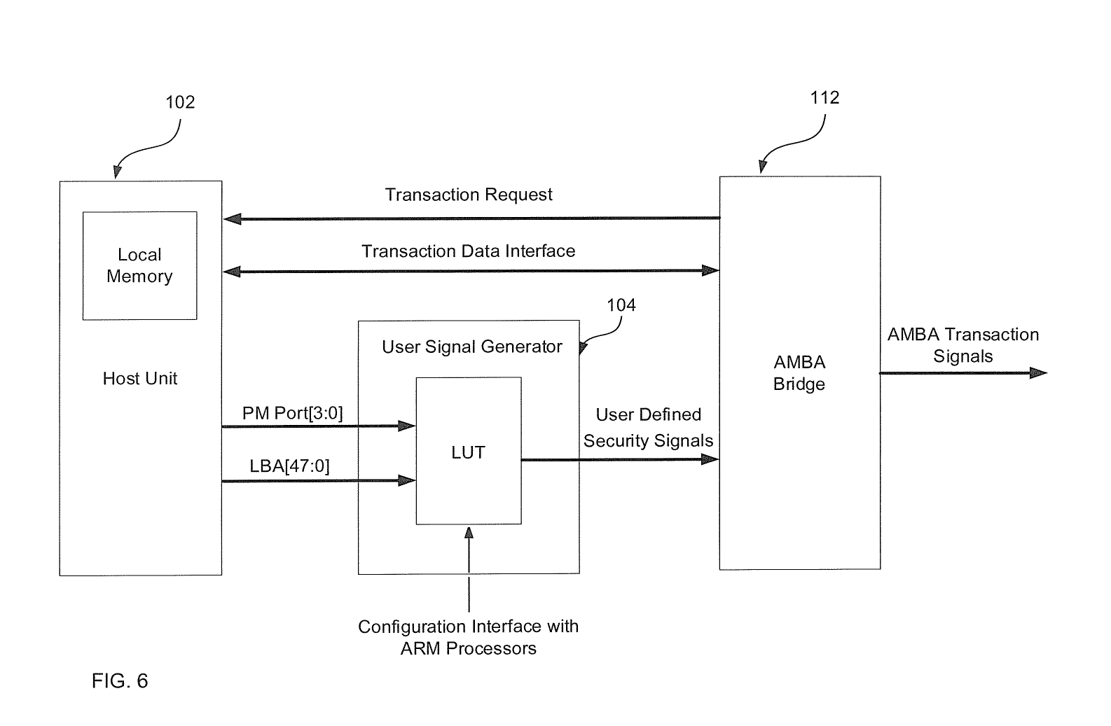

In more detail, the host unit 102 is instructed by an application (e.g., a software application) to obtain data stored in a specific storage space of a specific SATA HDD based on an external storage address and store the data in the storage unit 108. The external storage address may be PM Port and LBA information. As shown in FIG. 6, after the host unit 102 obtains the data from an external device based on the external storage address, the host unit 102 stores the data in a local memory of the host unit 102, and sends a transaction request (for example, a DMA request) to an AMBA bridge 112. The transaction request includes storage location and size information of the data now stored in the local memory of the host unit 102, and the initial internal storage address pre-assigned by the device 300 for the data. The AMBA bridge 112 may work as a DMA master. The AMBA bridge 112 obtains the data from the local memory of the host unit 102 based on the storage location and size information of the data included in the transaction request. The user signal generator 104 obtains the external storage address of the data (for example, PM Port and LBA information) from the host unit 102.

At 402, the user signal generator 104 generates a user defined security signal for the data based on the external storage address of the data, and sends the user defined security signal to the AMBA bridge 112. The user defined security signal indicates a security level of the data. The security level of the data indicates the level of security protection required by the data when the data is stored in the storage unit 108. In more details, for example, a LUT (look up table) may be implemented in the user signal generator 104 for generating user defined security signals. A security level mapping rule is configured in the LUT. Relationships between security levels and external storage addresses on external devices are defined in the security level mapping rule. Using the security level mapping rule, the user signal generator 104 determines the security level of the data from the external storage address (PM Port and LBA information) of the data, and indicates the security level of the data in the user defined security signal of the data.

The security level mapping rule may be configured by ARM processors 114 working in a security mode through the configuration interface of the user signal generator 104. The user signal generator 104 may be an AMBA user signal generator.

After the AMBA bridge 112 receives the data from the host unit 102 and the user defined security signal of the data from the user signal generator 104 respectively, the AMBA bridge 112 generates an AMBA transaction signal which includes the data and user defined security signal of the data, and sends the AMBA transaction signal to the storage address determining unit 106.

At 403, the storage address determining unit 106 determines the internal storage address in the storage unit 108 for the data based on the security level of the data.

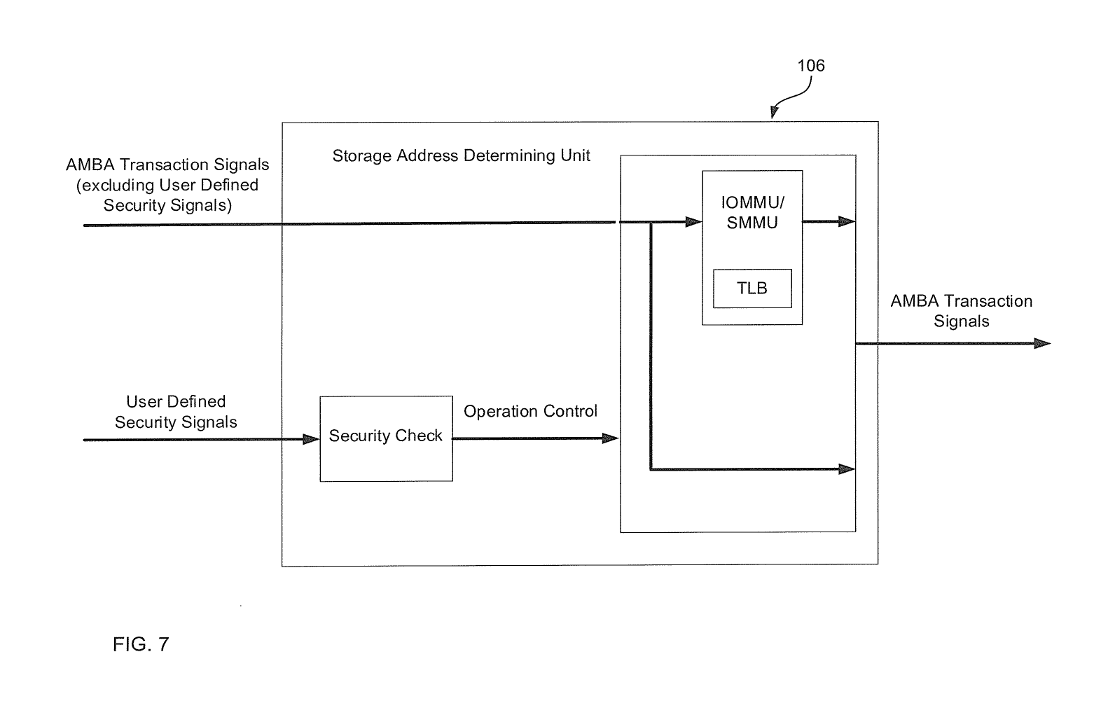

In FIG. 7, an IOMMU/SMMU is used as the MMU in the storage address determining unit 106. However, other kinds of MMU may also be used as the MMU in the storage address determining unit 106.

At 404, the data is stored at the final internal storage address in the storage unit 108, and the level of security protection provided for the data corresponds to the security level of the data.

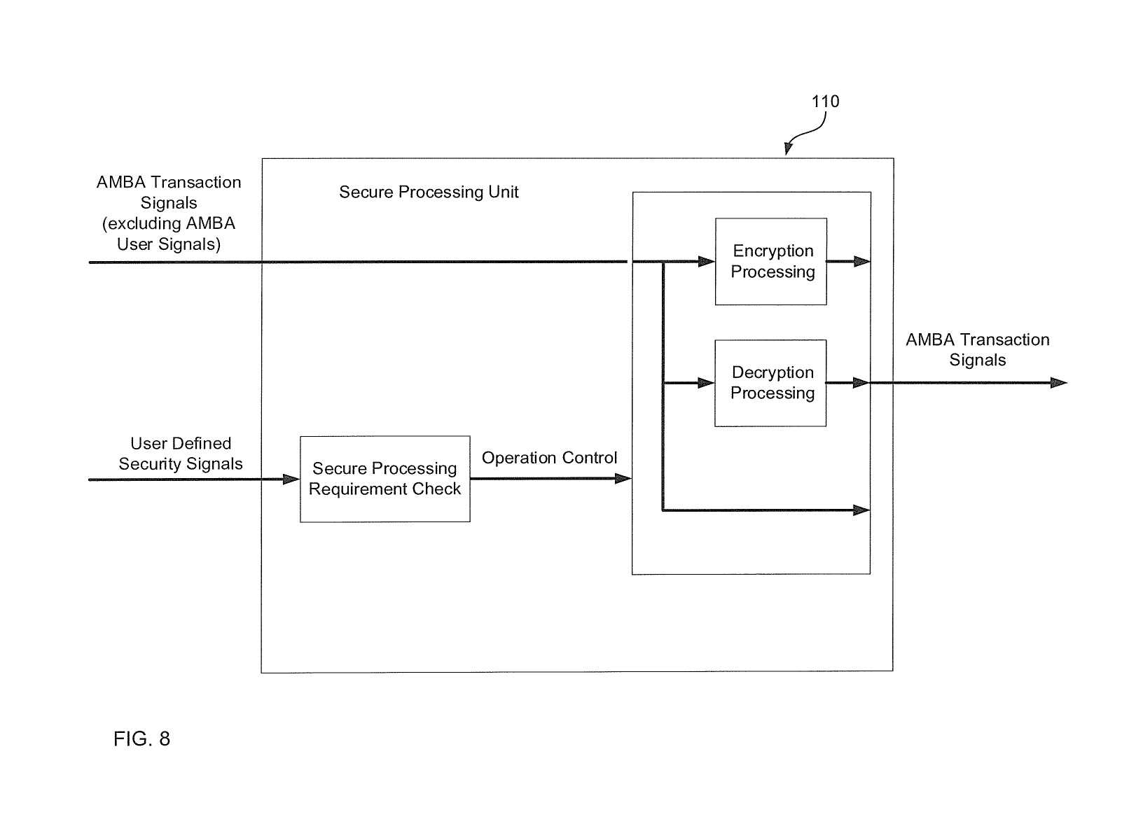

In FIG. 3, the secure processing unit 110 is configured between the storage address determining unit 106 and the storage unit 108. But this is an exemplary embodiment. The secure processing unit 110 may also be configured between the storage address determining unit 106 and the AMBA bridge 112. As shown in FIG. 8, the secure processing unit 110 receives the AMBA transaction signal of the data, determines if a secure processing is required to be performed on data based on a secure processing requirement of the data before the data is stored into the storage unit 108, and performs a corresponding secure processing on the data based on the secure processing requirement if the secure processing unit 110 determines the secure processing is required to be performed on the data.

The device disclosed in the present application determines the security level of the data based on the external storage address of the data in the external device, and determines the internal storage address in the device based on the security level. At different internal storage address, the data can obtain a different level of secure protection which corresponds to the security level of the data.

In the foregoing specification, the invention has been described with reference to specific examples of embodiments of the invention. It will, however, be evident that various modifications and changes may be made therein without departing from the broader spirit and scope of the invention as set forth in the appended claims.

In the claims, the words ‘comprising’ and ‘having’ do not exclude the presence of other elements or steps then those listed in a claim. The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A device for secure data storage, comprising:
a host unit configured to obtain data stored on an external device at an external storage address;
a user signal generator configured to generate a user defined security signal based on said external storage address of said data that indicates a security level of said data;
a storage address determining unit configured to determine an internal storage address for said data based on said security level of said data; and
a storage unit configured to store said data at said internal storage address corresponding to said security level.

2. The device of claim 1, wherein said user signal generator determines said security level of said data using a security level mapping rule between security levels and external storage addresses of data on external devices.

3. The device of claim 1, wherein said storage address determining unit determines said internal storage address for said data using an internal storage address mapping rule between security levels and internal storage addresses in said storage unit.

4. The device of claim 3, wherein different internal storage address mapping rules are used by said storage address determining unit to determine said internal storage address for data with different security levels.

5. The device of claim 3, wherein said storage address determining unit further comprises a memory management unit (MMU), and wherein if said security level of said data is equal to or higher than a predetermined security level, said MMU maps an initial internal storage address pre-assigned by said device for said data into said internal storage address of said data based on said internal storage address mapping rule.

6. The device of claim 5, wherein said MMU includes a translation look-aside buffer (TLB), and wherein if said security level of said data is equal to or higher than a predetermined security level, said TLB is used to map an initial internal storage address pre-assigned by said device for said data into said internal storage address of said data based on said internal storage address mapping rule.

7. The device of claim 3, wherein if said security level of said data is lower than a predetermined security level, said storage address determining unit uses an initial internal storage address pre-assigned by said device for said data as said internal storage address of said data according to said internal storage address mapping rule.

8. The device of claim 1, further comprising:
a secure processing unit that determines if a secure processing is required to be performed on said data according to a secure processing requirement of said data before said data is stored in said storage unit, and performs said secure processing on said data based on a result of said determination.

9. The device of claim 8, wherein said secure processing requirement is indicated by said user defined security signal.

10. The device of claim 8, wherein said secure processing requirement is determined based on said security level of said data.

11. The device of claim 8, wherein said secure processing includes encryption or decryption process.

12. A method for secure data storage, comprising:
obtaining data stored on an external device at an external storage address;
generating a user defined security signal based on said external storage address of said data that indicates a security level of said data;
determining an internal storage address for said data based on said security level of said data; and
storing said data at said internal storage address corresponding to said security level.

13. The method of claim 12, further comprising:
determining said security level of said data using a security level mapping rule between security levels and external storage addresses of data on external devices.

14. The method of claim 12, wherein determining said internal storage address for said data based on said security level of said data comprises:
determining said internal storage address for said data using an internal storage address mapping rule between security levels and internal storage addresses of said storage unit.

15. The method of claim 14, wherein different internal storage address mapping rules are used to determine said internal storage address for data with different security levels.

16. The method of claim 14, wherein determining said internal storage address for said data using an internal storage address mapping rule between security levels and internal storage addresses of said storage unit comprises:
if said security level of said data is equal to or higher than a predetermined security level, using a memory management unit to map an initial internal storage address pre-assigned for said data into said internal storage address of said data based on said internal storage address mapping rule.

17. The method of claim 14, wherein determining said internal storage address for said data using an internal storage address mapping rule between security levels and internal storage addresses of said storage unit comprises:
if said security level of said data is equal to or higher than a predetermined security level, using a memory management unit with a translation look-aside buffer (TLB) to map an initial internal storage address pre-assigned for said data into said internal storage address of said data based on said internal storage address mapping rule.

18. The method of claim 14, wherein if said security level of said data is lower than a predetermined security level, using an initial internal storage address pre-assigned for said data as said internal storage address of said data according to said internal storage address mapping rule according to said internal storage address mapping rule.

19. The method of claim 12, further comprising:
determining if a secure processing is required to be executed on said data according to a secure processing requirement of said data before said data is stored, and
performing said secure processing on said data based on a result of said determination.

20. The method of claim 19, wherein said secure processing requirement is indicated by said user defined security signal, and determined based on said security level of said data.

21. (canceled)

22. (canceled)
